(19) United States
(12) Patent Application Publication
(10) Pub. No.: US 2005/0217707 A1
(43) Pub. Date: Oct. 6, 2005

(54) Selective processing of microelectronic workpiece surfaces

(76) Inventors: Brian K. Aegerter, Kalispell, MT (US); Curt T. Dundas, Kalispell, MT (US); Tom L. Ritzdorf, Big Fork, MT (US); Gary L. Curtis, Loveland, CO (US); Michael Jolley, Beaverton, OR (US)

Correspondence Address: PERKINS COIE LLP/SEMITOOL, PO BOX 1208, SEATTLE, WA, 98111-1208, US

(21) Appl. No.: 11/133,909

(22) Filed: May 21, 2005

Related U.S. Application Data
(63) Continuation of application No. 10/632,495, filed on Jul. 31, 2003.
Application No. 10/632,495 is a division of application No. 09/672,572, filed on Sep. 28, 2000, now Pat. No. 6,632,292.
Application No. 09/672,572 is a continuation-in-part of application No. 09/437,926, filed on Nov. 10, 1999, now Pat. No. 6,413,436.
Application No. 09/437,926 is a continuation of application No. PCT/US99/05674, filed on Mar. 15, 1999.
Application No. PCT/US99/05674 is a continuation-in-part of application No. 09/041,649, filed on Mar. 13, 1998, now Pat. No. 6,318,385.
Application No. PCT/US99/05674 is a continuation-in-part of application No. 09/113,435, filed on Jul. 10, 1998, now Pat. No. 6,264,752.
Application No. PCT/US99/05674 is a continuation-in-part of application No. 09/041,901, filed on Mar. 13, 1998, now Pat. No. 6,350,319.
(60) Provisional application No. 60/116,750, filed on Jan. 22, 1999.
(60) Provisional application No. 60/117,474, filed on Jan. 27, 1999.

(51) Int. Cl. B08B 3/00

(52) U.S. Cl. 134/33; 134/26; 451/46

(57) ABSTRACT

A processing fluid is selectively applied or excluded from an outer peripheral margin of the front side, back side, or both sides of a workpiece. Exclusion and/or application of the processing fluid occurs by applying one or more processing fluids to the workpiece as the workpiece is spinning. The flow rate of the one or more processing fluids, fluid pressure, and/or spin rate are used to control the extent to which the processing fluid is selectively applied or excluded from the outer peripheral margin.

### CROSS REFERENCE TO RELATED APPLICATIONS

This Application is a: Continuation of U.S. patent application Ser. No. 10/632,495 filed Jul. 31, 2003 and now pending, which is a Division of U.S. patent application Ser. No. 09/672,572 filed Sep. 28, 2000, now U.S. Pat. No. 6,632,292B1, which is a Continuation-in-Part of U.S. patent application Ser. No. 09/437,926 filed Nov. 10, 1999, now U.S. Pat. No. 6,413,436, which is a Continuation of International Application No. PCT/US99/05674, filed Mar. 15, 1999, designating the U.S. and published in English, which is a Continuation-in-Part to U.S. patent application Ser. Nos.:
09/041,649 filed Mar. 13, 1998, now U.S. Pat. No. 6,318,385;
09/113,435 filed Jul. 10, 1998, now U.S. Pat. Nos. 6,264,752; and
09/041,901 filed Mar. 13, 1998, now U.S. Pat. No. 6,350,319.

International Application No. PCT/US99/05674 and U.S. patent application Ser. No. 09/437,926 also claim priority to U.S. Provisional Patent Application Nos. 60/116,750 filed Jan. 22, 1999, and 60/117,474 filed Jan. 27, 1999.

The disclosures of the following Applications are incorporated herein by reference:
U.S. patent application Ser. No. 10/632,495;
U.S. Provisional Patent Application No. 60/117,474;
International Application No. PCT/US99/05674; and
U.S. patent application Ser. No. 09/437,711, filed Nov. 10, 1999, now U.S. Pat. No. 6,423,642.

### BACKGROUND

The fabrication of a microelectronic circuit and/or component from a substrate typically involves a substantial number of processes. Many of these processes involve the deposition of a thin film on the surface of the workpiece followed by contact with a processing liquid, vapor, or gas. In a known process for treating a microelectronic workpiece, such as a silicon wafer, on which microelectronic devices have been fabricated, thin-film layers are successively applied and etched to form, for example, a metallized interconnect structure. In a typical metallization process, both sides of a semiconductor wafer are coated with a protective film such as a silicon nitride or a silicon oxide. Thereafter, a barrier layer such as titanium nitride, tantalum or tantalum nitride is applied over a dielectric layer on the front side of the workpiece. A thin metal film, such as a copper film, is applied onto the barrier layer. In most instances, the thin film serves as an initial seed layer for subsequent electroplating of a further metal layer, such as a further copper layer. Due to manufacturing constraints, the thin film is not applied over an outer, peripheral margin of the front side.

Known techniques, such as physical vapor deposition (sputtering) or chemical vapor deposition, are typically used to apply the barrier layer and the thin film. Both methods can deposit copper onto the wafer bevel (the peripheral edge of the wafer), and in many cases this deposit is non adherent and can flake off in subsequent processing steps. After deposition of the barrier layer, additional layers may be deposited to the wafer front side edge. In instances in which a further metal layer is to be electroplated exterior to the thin film, one or more electrical contacts are connected to an outer margin of the thin film to provide plating power. Because subsequent layers are deposited with an edge exclusion, the previously deposited layers are left exposed.

Many of these layers allow copper to be deposited on them, but the adhesion is very poor and the copper may flake off during post processing. A typical copper example might be an exposed barrier layer such as Ti/TiN exposed to copper plating solution. Following electrochemical deposition, the barrier layer would have a copper film of low quality which would flake off easily. Removal of flaking or loose material is desirable as the flakes have potential to cause scratches in the polished surface, resulting in yield losses.

The outer margin of the front side is generally not available for fabricating the microelectronic devices since the present manufacturing processes limit the extent to which device structures can be formed at the outer margin. It would be highly desirable and would result in increased yield if surface area at the outer margin of the thin film were available for fabricating devices.

### SUMMARY

In a first aspect, a process is provided for applying a fluid to the first side and peripheral edge of the workpiece, while excluding the fluid from at least a majority of the second side of the workpiece. In another aspect, the fluid is applied to the first side of the workpiece, the peripheral edge, and an outer perimeter portion of the second side of the workpiece. The fluid may comprise an etchant to remove a metal film or oxide film from the exposed surface portions of the workpiece, to the exclusion of the remaining substantially non-exposed portion of the second side of the workpiece.

### BRIEF DESCRIPTION OF THE DRAWINGS

FIGS. 1A, 1B, 1C, and 1D are fragmentary, cross-sectional views of a microelectronic workpiece, such as a silicon wafer, at various stages of a known sequence of processing steps in accordance with prior art.

FIGS. 2A, 2B, 2C, and 2D are fragmentary, cross-sectional views of a microelectronic workpiece, such as a silicon wafer, at various stages of a novel sequence of processing steps.

FIG. 3 is a schematic representation of a system in which the present processes can be implemented.

FIGS. 4 and 5 illustrate designs that facilitate mutually exclusive processing of the upper and lower wafer surfaces.

FIG. 6 is a cut-away, perspective view of a reactor.

FIG. 7 is a cross-sectional view of the reactor, as taken through its central, vertical axis.

FIG. 8 is an enlarged detail of certain elements of the reactor.

FIGS. 9 and 10 are further enlarged details of a portion of what is illustrated in FIG. 8, as taken at different places around the reactor.

FIG. 11 provides an SEM photo of a perimeter edge portion of a wafer processed in accordance as described below.

FIG. 12 provides etching results for various chemistries useful as processing fluids.

### DETAILED DESCRIPTION

The present methods may apply to any process in which a processing fluid is selectively provided to or excluded from an outer margin of an electrochemically processed workpiece. They are particularly well suited for removal of a film, or a portion of a film, that has been deposited on a substrate by electrolytic or electroless processing, specifically metal films and oxide films. Thus the present methods are suitably used for removing or decreasing the thickness of metal films from select surfaces of a workpiece. The films may contain, for example, copper, copper alloys such as copper zinc, neon, zinc, chromium, tin, gold, silver, lead, cadmium, platinum, palladium, iridium, or rubidium. Such metal films are typically removed using solutions applied as described below, including an etchant such as an acid and preferably an oxidizing agent. Oxide films can also be suitably removed in whole or in part, including metal oxides, silicon oxides, and barrier and protective layers, such as by way of non-limiting examples, silicon nitride, silicon oxide, polysilicon, tantalum nitride, and titanium nitride.

The term “film” and “contaminant” are used interchangeably herein. The term “workpiece” is not limited to semiconductor wafers, but rather refers to substrates having generally parallel planar first and second surfaces and that are relatively thin, including semiconductor wafers, ceramic wafers, and other substrates upon which microelectronic circuits or components, data storage elements or layers, and/or micromechanical elements are formed.

A. Semiconductor Workpiece Processing

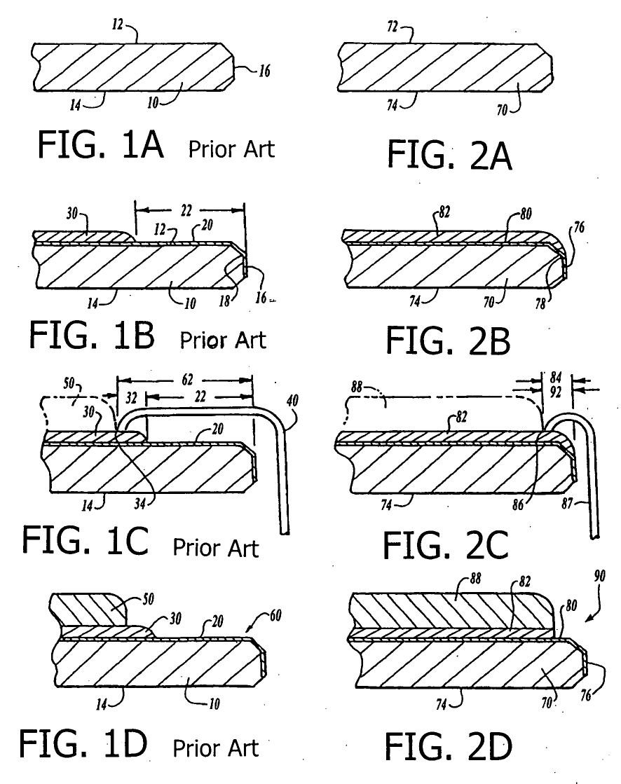

The known sequence of processing steps in accordance with the prior art begins with a semiconductor wafer 10, on which microelectronic devices (not shown) have been fabricated. As illustrated in FIG. 1A, the wafer 10 has a front, device side 12, a back, non-device side 14, and a beveled, outer perimeter 16. Via physical vapor deposition (sputtering) or chemical vapor deposition, a barrier layer 20 is applied over the front side 12 and over an upper portion 18 of the outer perimeter 16. A thin-film seed layer, such as a copper film 30, is applied over the barrier layer 20. Conventionally, the seed layer 30 is only deposited within the bounds of an outer margin 22 of the barrier layer 20, as illustrated in FIG. 1B. At an outer edge 32 of the copper film 30, one or more electrical contacts 40 to be used in providing electroplating power to the seed layer are placed in electrical contact with the copper film 30, as illustrated in FIG. 1C.

After the one or more electrical contacts 40 have been connected to the seed layer copper film 30 a further copper layer 50 from which interconnect structures and/or metallized devices are fabricated is electroplated onto the wafer 110 as illustrated in FIG. 1C. The electrical contact(s) 40 are then removed to provide the resultant multi film structure, shown generally at 60 in FIG. 1D. Beyond an inner boundary 34 of the outer margin 32 of the copper layer 50, an annular region 62 of the front side 12 is not available for fabricating such interconnect structures or metallized devices.

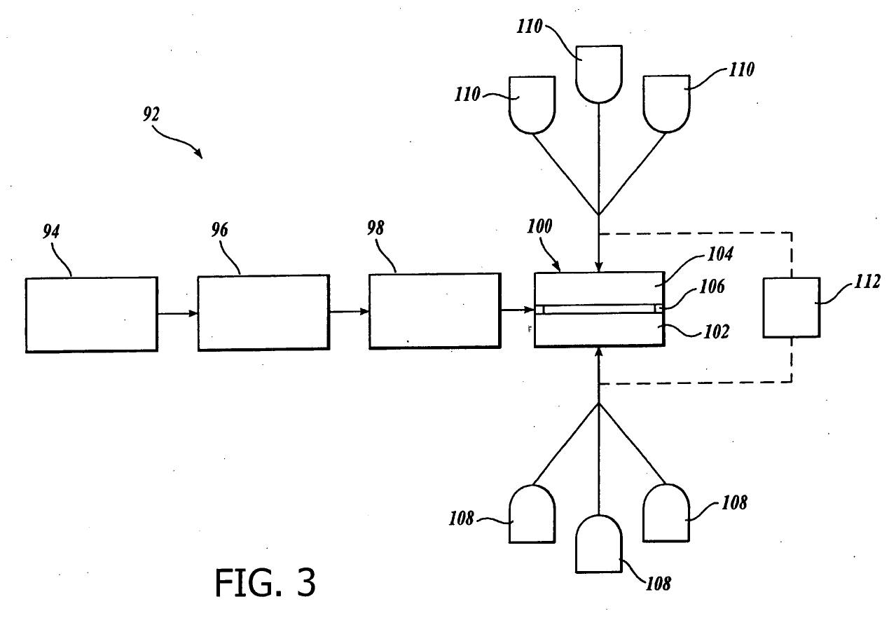

One example of novel sequence of processing steps begins with a silicon wafer 70, which is similar to the silicon wafer 10 before processing, and which has a front, device side 72, a back, non-device side 74, and a beveled, outer perimeter 76, as illustrated in FIG. 2A. Via physical vapor deposition (sputtering) or chemical vapor deposition, a barrier layer 80 is applied over the front side 72 and over an upper portion 78 of the outer perimeter 76. A thin seed layer, such as a copper film 82 is applied over the entire barrier layer 80, without exclusion from a peripheral outer margin 86, and covers the barrier layer 80 where applied over the front side 72 and over the upper portion 78 of the outer perimeter 76, as illustrated in FIG. 1B. At an outer edge 84 of the copper seed layer 82, one or more electrical contacts 87 to be used in electroplating are connected to provide electroplating power to the copper film 82, as illustrated in FIG. 2C. As illustrated, the outer edge 84 at which contact may be made for the supply of electroplating power illustrated in FIG. 2C is substantially closer to the peripheral edge than the process as illustrated in FIG. 1C.

A further copper film 88 from which metallized interconnects and/or microelectronic devices are fabricated is then applied using an electrochemical deposition process. As illustrated in FIG. 2C, the further copper film 88 is deposited within the outer margin 92 of the copper film 82. The electrical contact 86 is then removed leaving the resultant multi-layer structure shown generally at 90 of FIG. 2D. Metallized devices (not shown) and/or interconnects are formed by known techniques, from the resultant structure 90. After the copper layer 88 has been deposited, the seed layer 82, film 88, and/or barrier layer 80 may be removed from the outer margin 84 and, if desired peripheral edge 76 of the workpiece 70. Removal of at least layer 82 from the outer margin assists in preventing film flaking and cross-contamination problems that may occur during subsequent workpiece processing.

In accordance with an embodiment the process, processing fluid is selectively applied to the outer peripheral margin of at least the front side of the workpiece. Exclusion and/or application of the processing fluid occurs by applying one or more processing fluids to the workpiece as the workpiece and corresponding reactor are spinning about an axis of rotation that is generally aligned on the central orthogonal axis of the face of the workpiece being processed. The flow rate of the one or more processing fluids, fluid pressure, and/or spin rate are used to control the extent to which the processing fluid is selectively applied to the outer peripheral margin.

B. Process Overview

The present methods can selectively remove a film, such as a metal film or oxide film, from selected surface portions of a semiconductor workpiece. The metal film or oxide film can be selectively removed from: a single side of the workpiece; the peripheral edge of the workpiece; the peripheral edge and back side of the workpiece; the peripheral edge and an exclusion zone defined by a narrow annular perimeter edge portion of the front side of the workpiece; or the back side, peripheral edge and exclusion zone. To remove such films, such as metal contaminants that are not desired on the peripheral edge and/or the back side, an etchant solution is utilized which first oxidizes the metal and then solubilizes the oxidized metal to remove it from the selected surface portion. Oxide films may likewise be removed from selected surfaces of the workpiece using an acidic etchant. While the back side and/or peripheral edge is being etched, the front or device side of the semiconductor wafer may be left unprocessed, or may be exposed to an inert material such as a purge gas (e.g., nitrogen or helium), to a rinse such as deionized water, or to another processing fluid such as a more highly diluted etchant. The front side of the wafer (excluding the exclusion zone) is either left unprocessed, or is processed to a lesser degree without damage to the underlying devices, metal interconnects or semiconductor layers.

The present processes are adapted for removal of metal films such as copper ion contamination that is deposited on the peripheral bevel edge or the back side of a wafer during previous processing steps. For example, copper ion contamination can be removed from the bevel edge and back side, and additionally bulk copper can be selectively removed by a reduction in thickness from all areas of the substrate including the front or device side, to a predetermined extent. While reference is made herein to treating a bevel edge, it should also be understood that the described methods are adaptable for treating non-beveled edges such as flatted edges of semiconductor wafers.

C. Apparatus

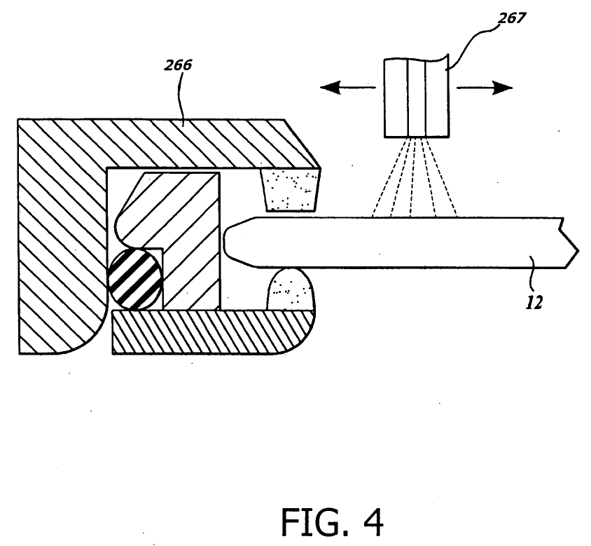

A system 92 useful for carrying out the present processes is illustrated in FIG. 3. FIG. 3 includes one or more preprocessing stations 94, in which a substrate that is to be electrochemically processed is prepared. In the case of a semiconductor wafer, the processing station 94 may be a chemical vapor deposition or physical vapor deposition station, such as for applying a barrier layer to a workpiece. The thusly prepared workpiece is then moved to one or more further processing stations 96, where, for example, a thin metal film such as a seed layer may be deposited on the substrate. Additional process steps may be incorporated as required to complete preparation of the workpiece for electrochemical treatment, such as the application of a metal film. The workpiece then is passed, either manually or under automated control, to a reactor 98, in which the metal film is to be deposited. In the case of a semiconductor wafer this may be an electroplating reactor 98, in which metal is deposited over the seed layer to the front or device side of the wafer, with potential contamination of the bevel edge and back side of the wafer.

The semiconductor wafer is then moved to an etching reactor 100, in which the surfaces of the workpiece are to be selectively treated to remove metal film or oxide film. The reactor 100 provides for selective etching of the back side, bevel edge and/or perimeter exclusion zone of a semiconductor wafer. The workpiece is received within a chamber defined within the reactor 100, with a first side of the workpiece being exposed to a lower chamber portion 102 and a second side of the workpiece being exposed to an upper chamber portion 104. The terms “upper” and “lower” are used herein for convenience, and other orientations are also encompassed by the invention.

The reactor 100 may be sealed, or may have fluid outlets at a perimeter edge portion 106 of the reactor. The side of the workpiece exposed to the lower chamber 102 may then be selectively supplied with one or more fluids from fluid supplies 108, such as deionized water for rinsing, chemical solution for etching or other processing, or an inert fluid such as nitrogen. In addition to or in lieu of fluids being supplied from the supplies 108 to the lower chamber 102, one or more fluids may be selectively supplied from one or more fluid supplies 110 to the upper chamber 104. Again, fluid supplies 110 may supply a chemical processing fluid, deionized water, or purge gas such as nitrogen. Supply of the various fluids is controlled by a programmable controller 112 that operates valves or pumps supplying the various fluids. Fluid may be supplied only to one side of the workpiece, such as a chemical solution provided to etch the back side and/or peripheral edge, with no fluid being supplied to the opposing second side of the workpiece. In the preferred embodiment, however, while the first side is being supplied with a chemical solution, the second side is being supplied with an inert gas or deionized water rinse, or an alternate processing solution. After etching, the etched side of preferably both sides of the wafer are supplied with deionized water rinse, spun to remove fluids, and dried with heated nitrogen.

Various configurations of reactors may be used. By way of example, the processes described can be advantageously practiced in one of a variety of reactors illustrated and described in U.S. Pat. Nos. 6,413,436 and 6,423,642, incorporated herein by reference. Rather than relying on the rotation of the workpiece, the processing fluid could also be selectively driven by pumps.

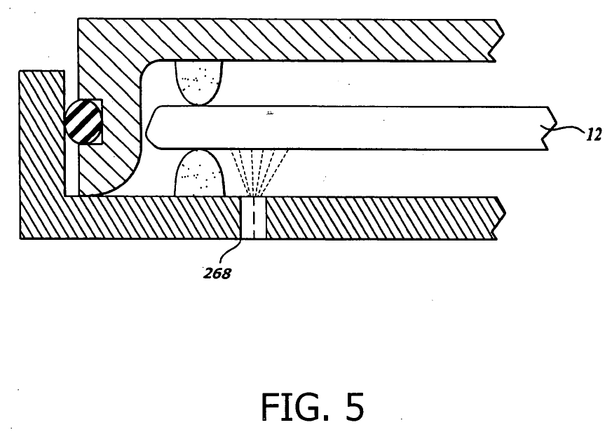

FIGS. 4 and 5 illustrate two alternate embodiments for peripheral edge and front side exclusion zone treatment. Referring to FIG. 4, the peripheral edge of the wafer 12 is engaged by an edge seal 266, while a nozzle 267 positioned above the front side exclusion zone, radially outboard from the center of the wafer, applies etchant or other solution to the exclusion zone. Alternately, if treatment of the entire front side, or treatment of the back side, is desired, multiple nozzles can be used at different radial locations, or the nozzle can move inwards and outwards while applying the treatment solution. FIG. 5 illustrates a still further embodiment, in which rather than a nozzle 267, an inlet 268 is provided for application of a fluid above the exclusion zone or at other locations through the reaction chamber wall onto the side of the wafer to be treated.

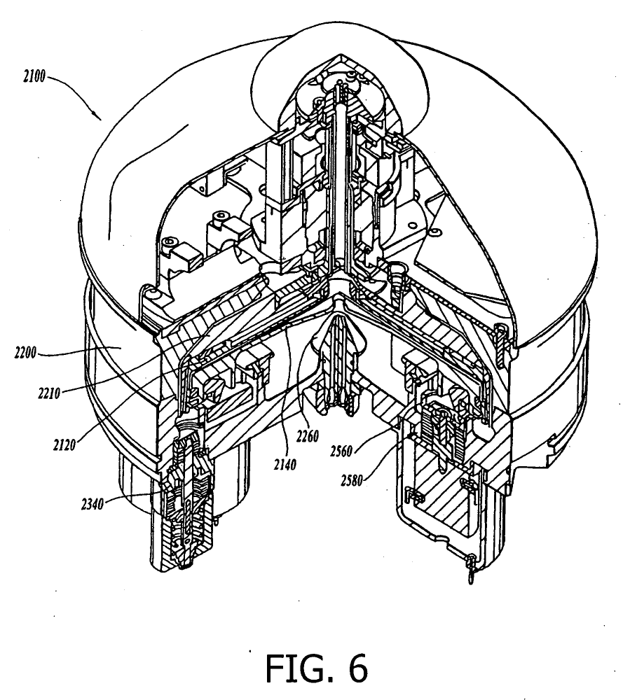

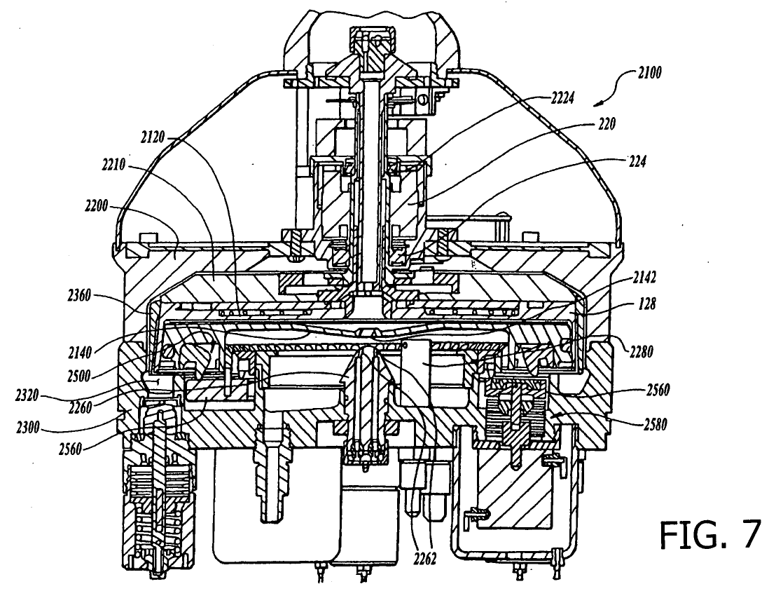

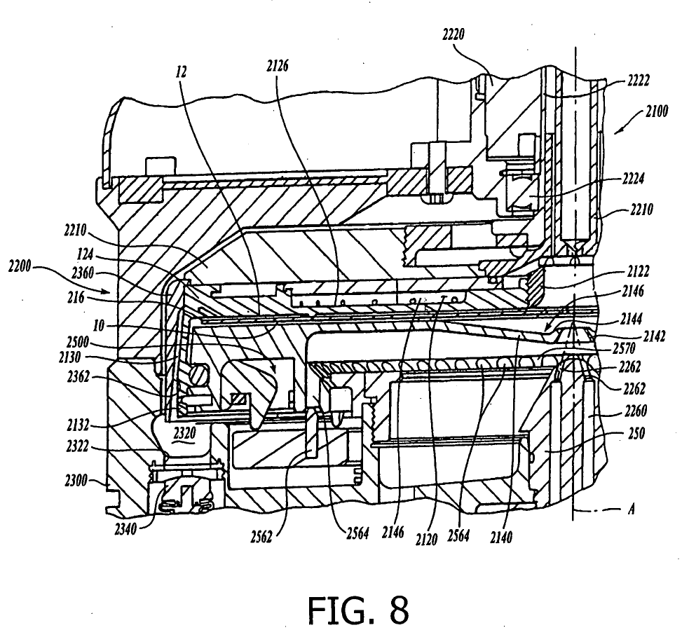

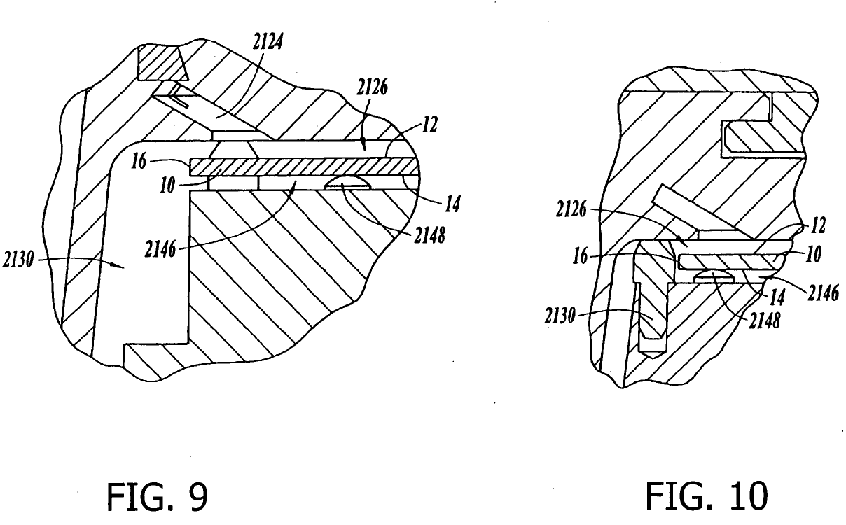

With reference to FIGS. 6-10, a reactor 2100 for processing a microelectronic workpiece, such as a silicon wafer 10 has an upper chamber member that includes an upper chamber wall 2120 and a lower chamber member that includes a lower chamber wall 2140. These walls 2120, 2140, are arranged to open so as to permit a wafer 10 to be loaded into the reactor 100 for processing, by a loading and unloading mechanism (not shown) that, for example, may be in the form of a robot having an end effector. These walls 2120, 2140, are arranged to close so as to define a capsule 2160 supporting a wafer 10 in a processing position, between these walls 2120, 2140.

The reactor 2100, which defines a rotation axis A, has a head 2200 containing a rotor 2210, which mounts the upper chamber wall 2120, and mounting a motor 2220 for rotating the rotor 2210 and the upper and lower chamber walls 2120, 2140, when closed, around the axis A, conjointly with a wafer 10 supported in the processing position. The motor 2220 is arranged to drive a sleeve 2222, which is supported radially in the head 2200, by rolling-element bearings 2224. The head 2200 is arranged to be raised for opening these walls 2120, 2140, and to be lowered for closing these walls 2120, 2140.

The upper chamber wall 2120 has an inlet 2122 for processing fluids, which may be liquid, vaporous, or gaseous, and the lower chamber wall 2140 has an inlet 2142 for such fluids, which for a given application may be similar fluids or different fluids. The head 2200 mounts an upper nozzle 2210, which extends axially through the sleeve 2222 so as not to interfere with the rotation of the sleeve 2222. The upper nozzle 2210 directs streams of processing fluids downwardly through the inlet 2122 of the upper chamber wall 2120.

The upper chamber wall 2120 includes an array of similar outlets 2124, which are spaced similarly at uniform angular spacings around the vertical axis A. In the disclosed embodiment, thirty-six such outlets 2124 are employed. Each outlet 2124 is spaced outwardly from the vertical axis A by a comparatively larger radial distance and is spaced inwardly from the outer perimeter 16 of a wafer 10 supported in the processing position by a comparatively smaller radial distance, such as a distance of approximately 1.5 millimeters or other desired edge exclusion zone.

When the upper and lower chamber walls 2120, 2140, are closed, they define a micro-environment reactor 2160 the having an upper processing chamber 2126 that is defined by the upper chamber wall 2120 and by a first generally planar surface of the supported wafer 10, and a lower processing chamber 2146 that is defined by the lower chamber wall 2140 and a second generally planar surface of the supported wafer opposite the first side. The upper and lower processing chambers 2126, 2146, are in fluid communication with each other in an annular region 2130 beyond the outer perimeter 16 of the supported wafer 10 and are sealed by an annular, compressible seal (e.g. O-ring) 2132 bounding a lower portion 2134 of the annular region 2130. The seal 2132 allows processing fluids entering the lower inlet 2142 to remain under sufficient pressure to flow toward the outlets 2134.

The reactor 2100 can perform a range of microfabrication processes. For example, reactor 2100 can execute a process that requires complete contact of a processing fluid at a first side of a workpiece and at only a peripheral margin portion of the second side thereof. Such processes may be realized because processing fluids entering the inlet 2142 of the lower chamber wall 2140 can act on the lower side 14 of a supported wafer 10, on the outer periphery 16 of the supported wafer 10, and on an outer margin 18 of the upper side 12 of the supported wafer 10 before reaching the outlets 2124, and because processing fluids entering the inlet 2122 of the upper chamber wall 2120 can act on the upper side 12 of the supported wafer 10, except for the outer margin 18 of the upper side 12, before reaching the outlets 2124.

The reactor 2100 can be used with control of the respective pressures of processing fluids entering the respective inlets 2122, 2142, to carry out a process in which a processing fluid is allowed to contact a first side of the workpiece, the peripheral edge of the workpiece, and a peripheral region of the opposite side of the workpiece. In one embodiment of such a process, a thin film of material is etched from the first side, peripheral edge of the workpiece, and peripheral region of the opposite side of the workpiece.

In a more specific embodiment of such a process, the process may employed in a metallization process that is used to form a microelectronic component and/or interconnect structures on a semiconductor wafer or the like. To this end, a thin film, such as the seed layer, is applied over a barrier layer on the front side and over at least a portion of the outer perimeter. After one or more intervening steps, such as electroplating of a copper layer or the like thereover, an etchant capable of etching the electroplating material, thin film material, and/or the barrier layer material is caused to flow selectively over only an outer margin of the first side while being concurrently prevented from flowing over other radial interior portions of the first side. Thus, one or more of the layers are removed from the outer margin of the first side while the layers remain intact at the portions of the first side that are disposed interior of the outer margin. If the etchant is driven over the opposite side and over the outer perimeter, as well as over the outer margin of the first side, the one or more layers are also removed from the outer perimeter of the wafer and, further, any contaminant that the etchant is capable of removing is stripped from the back side.

D. Processes and Solutions

The wafer is suitably placed into the reactor with its back side being the lower side (or in the opposing configuration for a differently configured reactor). An etchant capable of removing the copper is used as the processing fluid. The etchant is delivered by a pump to the lower chamber. An inert gas purge is preferably used as the processing fluid that is concurrently supplied and enters the upper chamber. The supply of an inert gas purge or an aqueous rinse, such as deionized water, is preferred to insure no vapor or etchant intrusion onto the majority of the first side (excluding the edge perimeter). However, the supply of fluid to the front side is not necessary, particularly for front sides coated with an exterior layer that is not vulnerable to etchant vapor, or from which a partial amount of film can be etched without a detrimental effect to the underlying layers. The etchant is caused to flow over the back side, over an outer perimeter of the silicon wafer, and over an outer margin (the exclusion zone) of the front side, but is prevented from flowing over the remainder of the front side except for the outer margin. After the etchant removes the thin film, any residual etchant is rinsed away, as with deionized water.

The processing fluid can suitably be a mixture of an acid and an oxidizing agent. If the thin film is a metal film, such as a copper film, a preferred etchant is a mixture of hydrofluoric acid and hydrogen peroxide, as an oxidizing agent. Preferably the solution includes 0.4 to 0.6 volume % HF, most preferably 0.5% HF, and 5 to 15% H₂O₂, most preferably 10 volume % H₂O₂, with the balance being deionized water. An alternative reagent is approximately 10% to 25% sulfuric acid with 5% to 15% hydrogen peroxide. An HF/H₂O₂ solution is preferred for stripping metal from wafers treated with a silicon nitride protective layer, which HF/H₂O₂ and H₂SO₄/H₂O₂ solutions are useful in stripping metal contamination from thermal oxide (silicon oxide) protective layers. Other concentrations of sulfuric acid from approximately 5% to approximately 98%, along with approximately 0% to 20% of an oxidizing agent, can be instead used to remove a metal film, such as a copper film.

The processing fluid can also be a mixture of sulfuric acid and ammonium persulfate. Other alternative enchants that can be instead used to remove a metal film, such as a copper film, include mixtures of hydrofluoric acid and a surfactant, mixtures of hydrofluoric and hydrochloric acids, mixtures of nitric and hydrofluoric acids, and EKC 5400, which is a proprietary chemical available commercially from EKC of Hayward, Calif. Mixtures of HF and HCl are suitably supplied as 0.4 to 0.6% HF and 5% to 15% HCl in deionized water. Mixtures of HNO₃ and HF are suitably supplied as 0.4 to 0.6% HF and 5% to 15% HCl in deionized water.

In place of hydrogen peroxide in the above etchant solutions, other oxidizers capable of etching metal films may be utilized. Dissolved ozone (O₃) has been found suitable for use in the above solutions in place of hydrogen peroxide, and is preferred due to its limited duration of solubility in water, such that after treatment the ozone breaks down and leaves a less hazardous waste fluid. Thus for example a suitable etchant solution for removal of metal films, such as copper films, includes 0.4 to 0.6% HF, most preferably 0.5% HF, and 10 parts per million ozone to an ozone saturated solution, preferably 20 parts per million ozone, in deionized water. When utilizing ozone as an oxidizer, apparatus suitably includes a mixing chamber into which ozone is introduced to the solution, such as through sparging ozone gas through the solution. In addition to HF/Ozone solutions, ozone may also be included as the oxidizer, in place of H₂SO₄, in the other solutions described above, such as the sulfuric acid solutions.

The etchant solution to be utilized will be selected, based on the disclosure contained herein, for use with a particular film. Turning to a specific application, treatment of the back side and bevel edge of a wafer for removal of copper contamination will be described in further detail. A preferred process sequence for a semiconductor wafer includes initially laying down a PVD or CVD barrier/adhesion layer onto the acidic wafer, followed by application of a seed layer of a metal onto the barrier layer to support subsequent deposition. The wafer is then subjected to electrochemical deposition to deposit the desired conductive film of copper over the front (device) side of the wafer, possibly excluding the outer perimeter of the substrate from the deposition, or potentially depositing copper to the edge and over the bevel of the wafer.

The wafer is then placed into a reaction chamber to perform a controlled etch of the back side, bevel edge, end of the seed layer metal and/or electroplated metal on the front side within a controlled distance from the perimeter edge of the substrate, to define a distinct exclusion zone from which copper has been removed by the etchant. Alternately, etchant may be supplied to remove metal from only the back side and bevel edge of the wafer, or to just remove metal contaminant from the back side of the wafer. The various process configurations will be described in terms of a process for exposing the back side, bevel edge and controlled perimeter edge exclusion zone to etchant, but it should be understood that any of these variations are possible.

After placement of the wafer in the etchant chamber, the chamber spins until it reaches a desired processing rotational speed, at which point any residual plating solution is rinsed from the front side of the wafer using deionized water. After rinsing, an inert gas stream is preferably (but not necessarily) supplied to the front (device) side of the wafer, while an etchant solution is delivered to the back side of the wafer. The etchant solution, such as use of the HF/H₂O₂ or H₂SO₄/H₂O₂ solutions disclosed above, is delivered at a concentration level and for a sufficient period of time to achieve the desired level of removal of copper ions from the back side and bevel, as well as the front side exclusion zone. After cleaning of the back side and etching of the bevel and front side exclusion zone in this fashion, the wafer is rinsed with deionized water on both sides, spun to remove liquid, and then dried with inert gas such as heated nitrogen.

The following tables I and II illustrate suitable sets of process steps to his back side cleaning and bevel etching:

TABLE 1
Suitable Cu Backside Clean and Bevel Etch Recipes

| Step | Description | Time | D1 | N₂ | Chem. |
|---|---|---|---|---|---|
| 1 | Rinse 1 | 0:10-0:30 | Front | | |
| 2 | Spin off | 0:05 | | Front | |
| 3 | Etch | 0:20-0:40 | | Front | Back |
| | | (preferably | | | |
| | | 0:30) | | | |
| 4 | Rinse 2 | 0:10-0:30 | Front, Back | | |
| 5 | Purge | 0:05 | Front, Back | Front, Back | |
| 6 | Rinse 3 | 0:10-0:30 | Front, Back | | |
| 7 | Dry | 0:60 | | Front, Back | |

TABLE II
Suitable Cu Backside Clean and Bevel Etch Recipe

| Step | Description | Time | Supply |
|---|---|---|---|
| 1 | Etch/process | 0:20-0:60 | Chemical to one or both sides; |
| | | | N2 alternate |
| 2 | Rinse | 0:10-0:30 | D1 rinse to front and back |
| 3 | Dry | 0:30-0:60 | N2 Purge to front and back; dry |

The above sequence times and sequence steps are provided by way of example only, and are not intended to limit the invention. Other sequence arrangements, such as single rather than multiple rinses, and rinsing or etching for different periods of time, are also within the scope of the present invention.

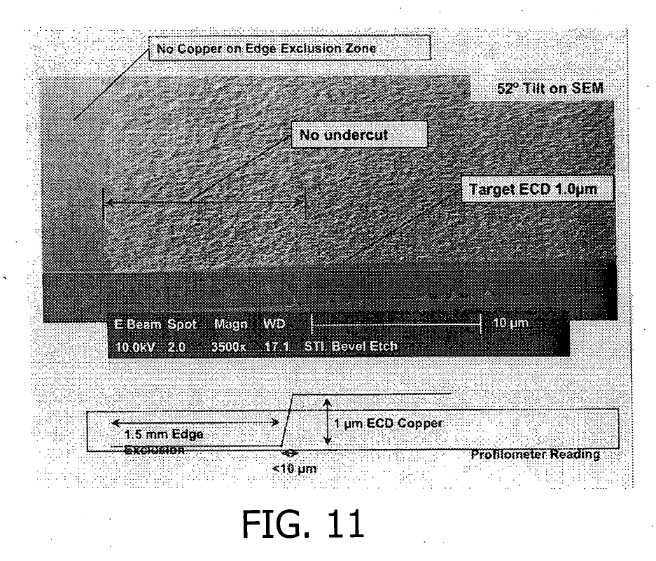

Use of a diluted sulfuric acid and peroxide solution, including approximately 10 parts H₂SO₄ to thirty parts H₂O₂ in deionized water, for an etchant exposure of approximately 30 seconds, results in removal of copper films of less than approximately 1.5 microns and achieves a back side clean of less than or equal to 5-10 copper atoms/cm². FIG. 11 provides a scanning electron microscope photo of the exclusion zone formed on the front side of a wafer treated with this process, yielding a clean etch exclusion zone (as well as clean bevel edge and back side (not shown)), and a distinct demarcation between the exclusion zone and the substantially unaffected copper film on the remainder of the front side.

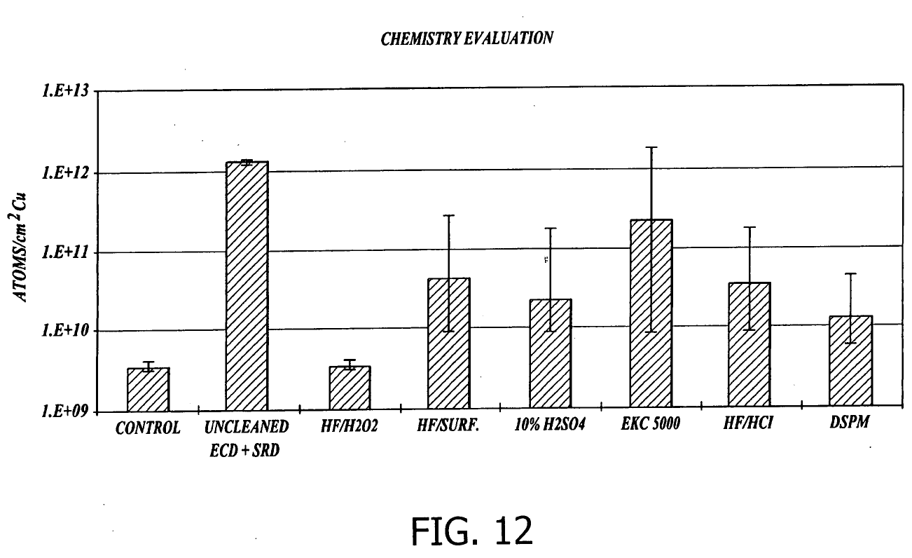

While the specific example above uses a dilute sulfuric acid and hydrogen peroxide solution, as noted above other solutions are suitably used. FIG. 12 provides results for use of various solutions on test wafers prepared by treating the polished side of bare silicon wafers with an acid copper solution. The acid copper solution was then rinsed from the wafer, and then the back side was cleaned and the edge bevel etched in accordance with the described processes and apparatus. Post cleaning analysis was done using a TXRF detector, with detection limits being roughly 7-9 E¹⁰ atoms per centimeter square. FIG. 12 provides comparative post-processing copper residues for an untreated wafer (“control”), for the acid-copper treated wafer (“uncleaned ECD+SRD”), and various etchant solutions. Specimens showing a post cleaning copper contamination level of less than 1 E¹⁰ atoms were judged to be suitable. Specifically, cleaning with a hydrogen fluoride/hydrogen peroxide solution was found to yield cleaning at a level equal to that of an uncontaminated control specimen, while cleaning with a dilute sulfuric acid etchant, sulfuric acid/hydrochloric acid solutions, and DSPM (dilute sulfuric acid/hydrogen peroxide) solutions were also found to yield suitable results. The exact solution utilized will be selected in accordance with compatibility for other films on the substrate and other process solutions.

The described methods reduce the size of the annular exclusion zone on the front side of the wafer, which region is not available for fabricating interconnect structures and/or metallized components (see FIG. 2). All other dimensions being alike, the described methods, when used for bevel edge and front side exclusion zone cleaning, increases the surface area of a wafer available for fabricating interconnect structures and/or metallic components. It follows that this enables a greater yield of microelectronic devices from a silicon wafer of a given size. Advantageously, the process not only removes a thin film, such as a copper film, but also removes any contaminant, such as any copper or other metal, that the reagent is capable of solvating from the back side of the silicon wafer.

The present methods and apparatus have been illustrated with respect to a wafer. However, they have a wider range of applicability, for example, in the processing of disks and heads, flat panel displays, microelectronic masks, and other devices requiring effective and controlled wet processing. While the preferred embodiments have been illustrated and described, it will be appreciated that various changes can be made therein without departing from the spirit and scope of the invention.

1. Processing a microelectronic workpiece having a first side, a second side, and an edge, and a barrier layer on the second side and the edge of the workpiece, and a seed layer on the barrier layer, comprising:
applying a metal layer on at least part of the seed layer;
rotating the workpiece;
providing a liquid including an acid and an oxidizing agent onto an outer margin of the second side of the workpiece and onto the edge of the workpiece, with the liquid removing the seed layer from the outer margin and edge of the workpiece.

2. The process of claim 1 wherein the liquid comprises de-ionized water.

3. The process of claim 2 wherein the oxidizer comprises hydrogen peroxide.

4. The process of claim 2 wherein the oxidizer comprises dissolved ozone.

5. The process of claim 2 wherein the acid comprises hydrofluoric acid.

6. The process of claim 3 wherein the acid comprises hydrofluoric acid.

7. The process of claim 2 wherein the acid comprises sulfuric acid, hydrochloric acid, or nitric acid.

8. The process of claim 2 wherein the liquid comprises ammonium persulfate or ammonium fluoride

9. The process of claim 1 wherein the seed layer comprises copper.

10. The process of claim 9 wherein the workpiece comprises a silicon wafer.

11. The process of claim 2 with the liquid comprising:
a mixture of hydrofluoric acid and a surfactant; or
a mixture of hydrofluoric and hydrochloric acids, or
a mixture of nitric and hydrofluoric acids; or
a dry etch residue removal solution.

12. The process of claim 1 wherein the metal layer comprises copper, a copper alloy, zinc, chromium, tin, gold, silver, lead, cadmium, platinum, palladium, iridium, cobalt or rubidium.

13. The process of claim 1 wherein the outer margin extends 1-5 mm in from the edge.

14. The process of claim 2 wherein the metal layer is applied onto the seed layer over the outer margin, and wherein the liquid also removes the metal layer from the outer margin.

15. The process of claim 14 wherein the metal layer is also applied onto the seed layer at the edge of the workpiece, and wherein the liquid also removes the metal layer from the edge.

16. The process of claim 1 wherein the liquid removes any metal layer present at the outer margin and at the edge, and also removes the seed layer from outer margin and the edge, and where the liquid does not remove the barrier layer from the outer margin or the edge.

17. A method for processing a workpiece having two sides and an edge, and with a barrier layer on the workpiece, and with a seed layer on the barrier layer including on the edge of the workpiece, comprising:
plating a metal film onto the seed layer;
spinning the workpiece;
applying a liquid including de-ionized water, and an acid, and an oxidizer, to one side of the workpiece, with liquid flowing around the edge and onto the other side of the workpiece;
with the liquid removing the seed layer, and any metal film on the seed layer, at an outer margin and at the edge of the workpiece.

18. The method of claim 17 wherein the acid comprises hydrofluoric acid.

19. The method of claim 17 wherein the workpiece has a first side and a second side, and the outer margin is on the first side of the workpiece, and the liquid contacts the outer margin, the edge, and substantially the entire second side of the workpiece.

20. The method of claim 17 wherein the liquid is applied directly onto the outer margin.

21. Processing a microelectronic workpiece having a first side, a second side, and an edge, and a barrier layer on the second side and the edge of the workpiece, and a seed layer on substantially the entire barrier layer, comprising:
applying a metal layer onto the seed layer over substantially the entire the second side of the workpiece;
rotating the workpiece;
providing a liquid including an acid and an oxidizing agent onto an outer margin of the second side of the workpiece and onto the edge of the workpiece, with the liquid removing the seed layer and the metal layer from the outer margin, and the liquid removing the seed layer from the edge of the workpiece.

22. The process of claim 21 wherein the metal layer is also applied onto the seed layer over the edge of the workpiece, and with the liquid also removing the metal layer from the edge.

23. The process of claim 21 wherein the acid comprises hydrofluoric acid and the oxidizing agent comprises ozone.
